(19) United States
(12) Patent Application Publication
(10) Pub. No.: US 2016/0052654 A1
(43) Pub. Date: Feb. 25, 2016

(54) PROCESS TO MOLD AND FILL CONTAINERS AND FORM-FILLING MACHINE

(71) Applicant: KRONES AG, Neutraubling (DE)

(72) Inventors: Klaus Voth, Obertraubling (DE); Wolfgang Roidl, Deuerling (DE)

(21) Appl. No.: 14/826,030

(22) Filed: Aug. 13, 2015

(30) Foreign Application Priority Data
Aug. 20, 2014 (EP) 14181643.9

(51) Int. Cl. B65B 3/02; B65B 55/10; B65B 47/08; B29C 49/42; B65B 3/10

(52) U.S. Cl. CPC B65B 3/022; B29C 49/4268; B65B 3/10; B65B 47/08; B65B 55/10; B29L 2031/7158

(57) ABSTRACT

A process for molding and filling plastic containers and a form-filling machine to implement the process. The process is used for molding and filling of plastic containers. Preforms in hollow molds are reshaped into the containers by at least partial addition of an incompressible molding fluid under the impact of overpressure. Due to the condition that the containers are also filled with a product in the hollow molds, in which the molding fluid is replaced by the product or partially replaced by at least one component of the product, the temporal or technological effort for the production of the containers and for bottling of the product can be reduced.

### CROSS-REFERENCE TO RELATED APPLICATION

The present application claims priority to European Application No. 14181643.9, filed Aug. 20, 2014. The priority application, EP14181643.9, is hereby incorporated by reference.

### FIELD OF THE INVENTION

The invention relates to a process to mold and fill plastic containers, and a form-filling machine to implement the process according to the invention.

### BACKGROUND OF THE INVENTION

As known, plastic containers can be produced out of preforms in the stretch blow molding process.

As an alternative to inflating the containers with compressed air, the EP 1529620 B1 describes a process for hydraulic reshaping of preforms into plastic bottles. For this purpose, the preforms are at first heated, brought into a hollow mold and stretched there in a longitudinal direction. Further, mineral water or a similar substance is added with overpressure in order to produce the final container shape. The mineral water stays in the container so that a subsequent, separate filling step can be omitted.

The US 2011/0031659 A1 further describes a process in which a heated preform is stretched by means of a stretching rod and subsequently extended hydraulically into a container by means of an incompressible fluid, especially water. Then, the fluid is displaced by compressed air and flows out of the container.

### OBJECTS OF THE DISCLOSURE

The purpose of the present invention consists of further developing known systems and processes for molding and filling plastic containers in an advantageous manner. In particular, the machine use and/or working hours required to manufacture and fill plastic containers should be reduced.

### DESCRIPTION OF THE INVENTION

A form-filling machine comprises, according to the definition, at least one treatment station for expanding and forming of plastic preforms into plastic containers in a hollow mold and for filling of a substantially liquid product or at least a liquid or solid component of the product into the plastic containers.

Liquids, also those which contain dissolved carbon dioxide or similar substances, are, according to the definition, incompressible fluids, with regard to their function during molding and filling of the containers, in contrast to gases that are functionally defined as compressible fluids.

The process according to the invention is used for molding and filling containers made of plastic, whereby preforms are reshaped into the containers in hollow molds by means of at least partial introduction of an incompressible molding fluid under the effect of overpressure, and whereby the containers in the hollow molds are filled with a product by replacing the molding fluid with the product or partially with at least one component of the product. Therefore, the incompressible molding fluid is not identical to the liquid product filled into and/or mixed in the hollow mold.

The preforms are made of a thermoplastic polymer such as PET, PE, PP or a similar material and can be heated for reshaping in an upstream furnace in the conventional way.

The at least partial addition of an incompressible molding fluid shall mean that at least a part of the reshaping process, especially a final part of the reshaping process, takes place in the hollow mold through hydraulic pressing of the preform / container by means of an incompressible molding fluid and is complemented at most proportionally by pneumatic inflation by means of a compressible molding fluid such as compressed air.

The process according to the invention is particularly advantageous if the reshaping of the hollow mold is done by means of at least one incompressible molding fluid, if this molding fluid is removed completely from the container before the product is bottled and if there is a negative pressure in the container while the product is being bottled in the hollow mold.

An exclusively hydraulic pressing process of the preform has the advantage that a pressurized air supply for the treatment stations for the purpose of molding is not required. A partially pneumatic inflation process with a compressible molding fluid, however, can be advantageous especially for an initial pre-blowing process of the container in the hollow mold Likewise, the compressible molding fluid could be carbon dioxide of which at least a proportion will remain in the preform/container after pre-blowing and which will be subsequently dissolved in the incompressible molding fluid, which is added by means of overpressure, in order to carbonate the product.

With regard to its volume proportion, the molding fluid could be a main component of the product to be filled, especially a diluent for a product component that is maintained as a concentrate and added during filling, such as syrup. The product, for example a beverage, is then mixed in the container. Therefore, no negative pressure is preferably created in the container and/or only the volume proportion to be replaced by the product component is removed from the container.

For example, the molding fluid is then displaced proportionally through addition of the product component with overpressure during filling. The molding fluid and the product component are provided preferably through separate feed lines on the valve head but could also be transported serially through the valve head by means of a joint feed line.

Preferably, the preforms are mechanically stretched prior to and/or during the addition of the incompressible molding fluid. By means of a stretching rod, a systematic longitudinal deformation of the preform can be achieved or at least supported.

Preferably, the pressure of the incompressible molding fluid during deformation of the preforms is respectively changed in a controlled way. For example, the pressure level in the molding fluid can be substantially modified in a gradual manner. A fluid pressure level that exists at the beginning of the reshaping process could be followed by further pressure levels that do not necessarily have to be provided in a gradually increasing way. Pressure increase and decrease could be combined in a random order during the individual reshaping process in order to create for example different stretching rates in individual phases of the reshaping process. A hydraulic pressing process of the preform, however, is generally also possible in case of a consistent fluid pressure.

Preferably, the incompressible molding fluid is heated for the reshaping process, especially for a temporal fraction of the reshaping process, to a conditioning temperature for conditioning of the plastic material. Then, the incompressible molding fluid is cooled down again, preferably still during the reshaping process. Therefore, the temperature of the molding fluid is in particular higher at the beginning than at the end of the feeding process.

The conditioning temperature can for example influence the degree of crystallization and/or the crystallization speed of the plastic material. Hence, a thermally induced crystallization could possibly be prevented by a feeding process at a conditioning temperature of 80-90° C. Also, the conditioning temperature could be higher than an existing temperature in the preform during feeding of the molding fluid such as an average wall temperature in a defined area of the preform. Equally, crystallization of the plastic, that is mechanically induced through stretching, can be prevented systematically in defined phases of the reshaping process, especially when the conditioning temperature is higher than a temperature of the preform or of a defined area of the preform.

Feeding of a molding fluid, that has been cooled down in relation to the conditioning temperature, at the end of the reshaping process such as after reaching 90% of the final container volume or after the end of the reshaping process, supports a fast cooling of the container in order to ensure a desired mechanical stability of the container for the subsequent bottling process in the hollow mold and/or the removal of the container.

Pressure and/or temperature of the incompressible molding fluid can be adapted individually on each treatment station and/or be provided in the feed lines in an appropriate pressure range/temperature range. Pressure and/or temperature of the molding fluid can therefore be pre-set roughly in feed tanks, feed lines or similar devices and set accurately at the individual treatment zones and/or systematically modified chronologically within the individual reshaping intervals. To the same extent, an exclusively central adjustment of the pressure and/or temperature of the incompressible molding fluid would be possible.

The molding fluid preferably consists of sterile water and/or a sterilization agent that is preferably rinsed out of the container with particularly sterile water. Therefore, a recontamination of the preforms that are essentially sterilized during heating in a furnace due to their thermal history can be avoided. The produced container can be cleaned and/or sterilized additionally with an incompressible sterilization agent such as peracetic acid.

The sterilization agent is preferably removed from the container by rinsing with particularly sterile water. After a possibly proportional hydraulic reshaping process with sterilization agent, the container, which is not completely molded, can be first emptied through suction and subsequently molded further, preferably with sterile water, in a hydraulic process. Rinsing, however, would also be possible without a suction process, by means of preferably sterile water that displaces the sterilization agent from the container that has not yet or already reached its final shape.

In the particularly preferred filling process according to the invention, an internal negative pressure is created in the container for the filling of the product or the product components. The internal negative pressure in the container allows for a fast filling with product and/or product components. Therefore, only a valve that creates a connection to a feed tank and/or a product line needs to be opened. The product shoots out of the valve head into the container in a stream-like way, depending on the existing pressure difference. The internal negative pressure is, for example, between 0.6 and 0.9 bar. The container is preferably emptied completely prior to the creation of the negative pressure in the container, i.e. the molding fluid and/or the sterilization and/or the rinsing fluid is removed. The removal can be done, for example, by discharging the molding fluid (especially if the container is inserted in the hollow mold with the aperture facing downwards in a gravitational direction) or also by means of an at least partial removal of the molding fluid by suction with the fluid nozzle / filling nozzle and/or the stretching rod.

Preferably, the negative pressure is generated at least proportionally by sucking the molding fluid out of the container. For this purpose, the fully molded container is connected through the valve head to a negative pressure line/suction unit so that the molding fluid is removed from the container and that an internal negative pressure is created in one working step. This negative pressure is maintained or simply complemented for the subsequent bottling process. Hence, undesired penetration of ambient air into the container can be prevented at the same time.

To fill the product or the product component, an external negative pressure is preferably created on the outside of the container, which counter-acts the internal negative pressure on the container in a compensatory way. Therefore, an approximate pressure equilibrium can be created on the container wall, which prevents collapsing of the container, i.e. an inward contraction of the container wall and hence a reduction of the container volume during the bottling process.

The external negative pressure can be created for example through channels in the wall of the hollow mold that are also used, if appropriate, for venting during molding of the container. The area of the hollow mold in which the external negative pressure is created preferably has an appropriate hermetically sealed design towards the outside. This allows for an efficient compensation of the internal negative pressure, especially on a negative pressure level that is sufficiently low for a fast filling process within 0.2-0.5 s.

The product or the product component is preferably filled under overpressure conditions in the container that is impacted by internal negative pressure. Overpressure conditions in this sense exist, for example, when an overpressure is created in addition to a hydrostatic line pressure (for example because of a gradient between the product level in a feed tank and the fluid nozzle/filling nozzle), for instance through active energy input into a feed tank, a feed line, the valve head or a similar device. The hydrostatic pressure of the product will then be stabilized preferably through control of its filling level in a feed tank or the like.

Preferably, the containers are turned from a position with a downward facing outlet into a position with an upward facing outlet immediately before the filling process. The hollow molds can in principle be moved through the form-filling machine with the valve head facing downwards and/or with the valve head facing upwards. The orientation of the preforms/containers can change during circulation on the form-filling machine, especially for the reshaping process with the outlet facing upwards and for the removal of the molding fluid with the outlet facing downwards. Then, gravity will support and simplify the suction process of the molding fluid. During filling, the container will subsequently be transported again with the outlet facing upwards.

The form-filling machine according to the invention is suitable for the implementation of the process according to at least one of the above variants and comprises several treatment stations that are designed for selective introduction of the molding fluid into the preforms and for selective introduction of the product or the component of the product into the containers. Especially, valves that can be controlled by an electric control unit are available for selective introduction.

The treatment stations preferably comprise valve heads with feed lines, that lead through the valve heads and/or that can be locked in a controlled way, for the molding fluid and the product/the component of the product. The molding fluid and the product/product component can for example be fed in via separate feed lines and added separately by means of the valves provided in/on the valve head. The molding fluid and product/product component are fed into the preform/container by means of a fluid nozzle that is provided on the valve head. The fluid nozzle works as a combined molding nozzle (in the sense of a blowing nozzle) and filling nozzle (in the sense of a filling valve).

All the described variants are particularly advantageous for an at least proportionally hydraulic molding process of the containers. Containers that are molded exclusively pneumatically with pressurized air or the like, however, can also be filled in an especially efficient way in case of internal negative pressure in a form-filling machine. In that case, hydraulic lines, valves or similar devices for compressible molding fluids such as blowing air, carbon dioxide or similar substances are to be provided.

Therefore, especially the following variants can also be provided alternatively with a form-filling machine for molding and filling containers in hollow molds that comprises several hollow molds with valve heads that are configured for selective introduction of at least one compressible and/or incompressible molding fluid into the preforms under overpressure and for selective introduction of a product into the containers. Then, for example valves that can be electrically controlled separately are provided for the compressible molding fluid and the product in/on the valve head.

The form-filling machine preferably comprises suction lines, that lead through the valve heads and/or that are lockably controlled, to suck the molding fluid out of the containers and/or to create an internal negative pressure within the containers. Controlled locking is enabled for instance by electrically controlled valves.

Furthermore, the treatment stations preferably comprise sealing elements to seal mold parts, that develop respectively one of the hollow molds, hermetically in relation to each other and to the respective associated valve head. Hence, a negative pressure can be efficiently created and/or maintained within one of the reshaping spaces formed by the hollow mold and outside of the containers.

The hollow molds are preferably equipped with venting ducts that can be locked and/or connected to suction lines in a controlled way in order to create an external negative pressure in the hollow molds outside of the containers. For example, an electrically controlled three-way valve is particularly suitable for this purpose.

For example, the sealing elements are arranged alongside the internal hollow mold contour and fastened in lateral mold parts. Also, sealing elements could be provided in carrier shells for the lateral mold parts of the hollow mold. Further, sealing elements are preferably provided between lateral mold parts and a lower mold part as well as the valve head.

Moreover, the treatment stations preferably comprise compressors and/or heating elements for the molding fluid that can respectively be controlled individually. Therefore, pressure sequences and temperature curves can be generated separately at each treatment station and for each container.

The form-filling machine according to the invention is preferably based on a continuously rotatable carousel on which several treatment stations are fastened. Further, there is preferably a furnace to heat the preforms, which is coupled to the machine by means of an input star wheel or the like. They could, however, be also be provided directly by a connected injection molding machine with an appropriate input temperature. There is preferably also a sealing machine that is coupled to the system by means of an output star wheel or the like or provided in the area of the output star wheel. However, the containers filled with product can also be sealed while circulating on the carousel.

A preferred variant of the form-filling machine according to the invention is illustrated in the drawing. The figures show:

### BRIEF DESCRIPTION OF THE SEVERAL VIEWS OF THE DRAWINGS

FIG. 1 is a schematic top view of a preferred variant of the form filling machine of the present disclosure;

FIG. 2 is a schematic longitudinal section view of a preferred variant of a treatment station according to the present disclosure; and

FIG. 3 is a schematic display of preferred sealing agents for the hollow mold according to the present disclosure.

### DETAILED DESCRIPTION

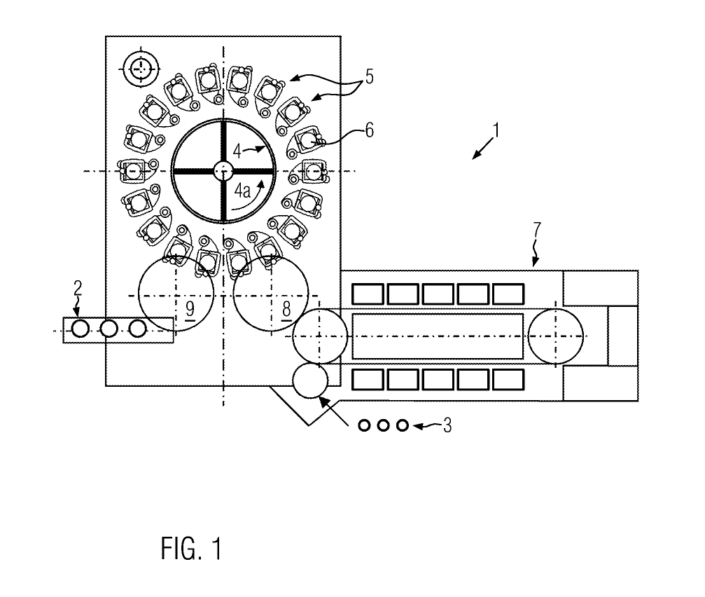

As can be seen in FIG. 1, the form-filling machine 1 according to the invention to mold containers 2 made of preforms 3 in a preferred variant comprises a carousel 4 that is rotatable especially with a continuous transportation movement 4a and on which several treatment stations 5 with hollow molds 6 to mold and fill the containers 2 move along a partially circular path (as indicated in FIG. 1) in the way that is known in principle.

At the beginning, the preforms 3 that are made of a thermoplastic polymer are heated in a furnace 7 for the subsequent molding process and transported to the treatment stations 5 by means of an input star wheel 8. The molded and filled containers 2 are transported to a transportation device or a sealing machine for the containers 2 (not shown) by an output star wheel 9. The containers 2 could equally be sealed in the transportation area of the output star wheel 9 or the carousel 4.

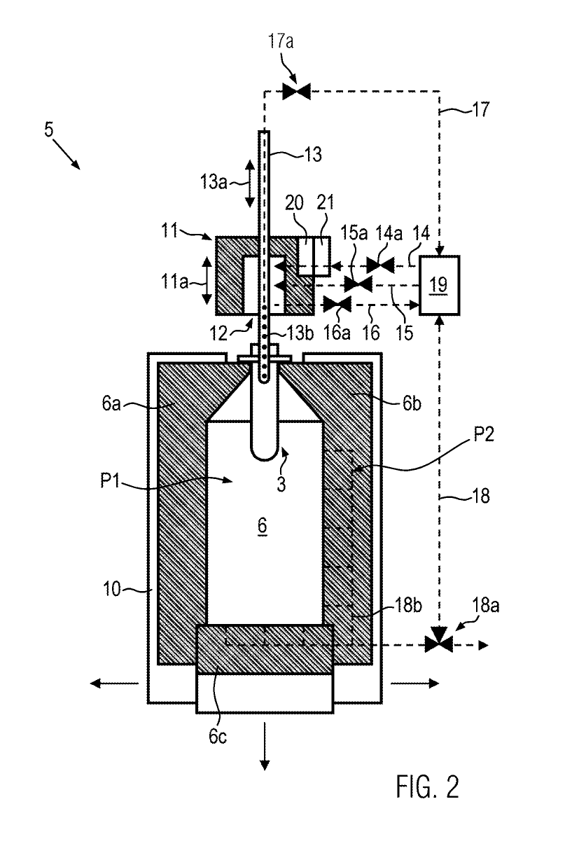

As indicated in FIG. 2, the treatment stations 5 according to the invention respectively comprise in a preferred variant a hollow mold 6 that consists of mold parts 6a-6c, which can be moved towards each other (see arrows in FIG. 2), and that is held by a multi-part mold carrier 10, as well as of respectively one valve head 11. By means of a lifting unit (which is in principle known and therefore not displayed), a lift 11a of the valve head 11 can be implemented in order to place the valve head onto the hollow mold 6, and onto the preform 3 that is positioned in it, by lowering it in a hermetic way. The lateral mold parts 6a, 6b can be tilted towards each other for the purpose of un-molding and are also called molding halves. The lower mold part 6c can be pulled off in a downward direction and is also called floor plate. The hollow mold 6 is opened/closed for example by means of a mechanical curve control system.

A fluid nozzle 12 that faces the hollow mold 6 and that enables fluid transportation into and out of the preform 3 is provided on the valve head 11. A stretching rod 13 is led through the valve head 11 in a pneumatically and hydraulically sealing way. By means of a further lifting unit (which is in principle known and therefore not displayed), a lift 13a of the stretching rod 13a in relation to the valve head 11 can be implemented in order to insert the stretching rod 13 through the fluid nozzle 12 into the preform 3 and consequently to stretch it mechanically in a longitudinal direction during reshaping.

FIG. 2 schematically indicates flowing paths/lines 14-18 for incompressible and compressible fluids in an exemplary way by means of dotted arrows. Pertaining electrically and/or pneumatically controllable valves 14a-18a for controlled opening and closing of the individual flow paths/lines 14-18 are only displayed schematically. In principle, all valves that are designed for the respective fluids, possibly also for cleaning and/or sterilization agents, are suitable for this purpose. The position of the valves 14a-18a in FIG. 2 was chosen for the purpose of a clear display. Especially the valves 14a-16a that are connected to the fluid nozzle 12 are preferably integrated in the valve head 11 in the sense of a valve block.

The fluid nozzle 12 is therefore connected to a feed line 14, that can be opened in a controlled way, for an incompressible molding fluid such as sterile water or the like. Furthermore, the fluid nozzle 12 is preferably connected to a separate feed line 15, that can be opened in a controlled way, for a liquid product or a component of the product such as a readily mixed beverage or a product concentrate that can be mixed with the molding fluid.

For a serial dosage of a product concentrate into the molding fluid that is available in the container 2 after molding, a joint feed line 14 to the valve head would also be an option. The feed line could then also be used for example to dose solid product components such as fruit pieces. Equally, there could be another feed line for this purpose. A line 17 that optionally leads through the stretching rod 13 would for example be suitable (after reversing the flow path shown in FIG. 2).

The fluid nozzle 12 is preferably connected to at least one suction line 16, that can be opened in a controlled way, for the molding fluid and/or generally for the evacuation of the container 2.

In the example, the suction line 17 is formed by a stretching rod 13 that is optionally pipe-shaped and by apertures 13b in the stretching rod to suck off, for example, molding fluid in the floor area of the container 2 systematically, fast and/or completely. The apertures 13b, however, could be designed in any shape and/or distributed at random on the stretching rod 13 and especially also be complemented or replaced by an aperture on the front side.

If the molding fluid is completely sucked off through the suction line 16 and/or the line 17, a suitable internal negative pressure P1 will preferably be created in the container 2 for the subsequent filling process.

There is preferably at least one pneumatic suction line 18 that can be used to create an external negative pressure P2 to impact between the hollow mold 6 and the container 2. The suction line 18 is then preferably connected to an electrically or pneumatically controlled three-way valve 18a and (only schematically indicated) venting ducts 18b.

The three-way valve 18a enables systematic venting of the hollow mold 6 during the expansion of the preform 3 and systematic evacuation between the hollow mold 6 and the container 2 during filling with the internal negative pressure P1. The external negative pressure P2 compensates the internal negative pressure P1 at least to the extent that thin container walls 2 will not be deformed in an inward direction in spite of the internal negative pressure P1. Consequently, the container 2 has its nominal volume during filling.

Furthermore, a media distributor 19 that is provided jointly for the treatment stations 5 on the carousel 4, for example a rotary distributor with annular ducts for fluids, is schematically displayed.

There is further a schematic indication of a hydraulic compressor 20 to create an overpressure in the particularly incompressible molding fluid individually for the respective treatment station 5 or to increase such overpressure starting from a pressure level in the feed line 14. Therefore, chronological sequences of the pressure in the molding fluid can be created in a controlled and reproducible manner during molding of the individual containers 2. The valve 14a could thereby also be provided in an advantageous way between the compressor 20 and the fluid nozzle 12.

Moreover, a heating element 21 for the molding fluid can be provided on the valve head 11, the compressor 20 and/or the feed line 14 in order to heat the molding fluid independently on each treatment station 5. Hence, chronological sequences of the temperature in the molding fluid can be created in a controlled and reproducible way for the molding process of the individual containers 2. In addition, the molding fluid can be heated to at least one desired conditioning temperature at which the material of the preform 3 can be systematically conditioned prior to or during the molding process, for example to influence crystallization in the plastic material.

Alternatively or as a proportion, the overpressure and/or the temperature could be set centrally for several treatment stations 5 or in the respective feed lines 14. Another possibility would be to provide several feed lines 14 on each treatment station 5 for the molding fluid at different pressure levels and/or temperature levels and to selectively add and/or mix the molding fluid from these feed lines during molding of the container 2.

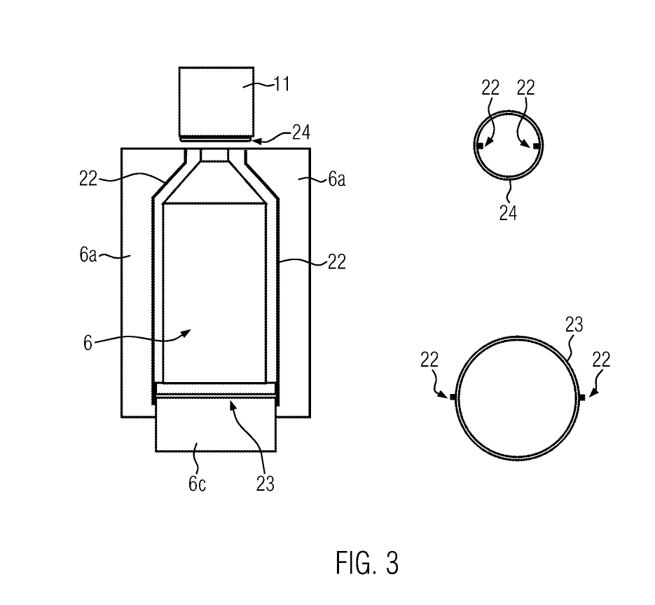

As can be seen especially in the schematic side view in the left half of FIG. 3, there are also sealing elements 22-24 that are used to hermetically seal the hollow mold 6 during filling of the container 2 towards the outside and against the valve head 11 in order to create and/or maintain the external negative pressure P2. The venting ducts 18b can be sealed hermetically and/or are connected in an airtight way to the suction line 18 by means of the three-way valve 18a for this purpose.

On the lateral mold parts 6a and/or 6b, lateral sealing elements 22 are preferably provided for example alongside the internal contour of the hollow mold 6 and fastened, for instance, in a respective valve seat on the mold parts 6a, 6b and located essentially in their common parting plane when the hollow mold 6 is closed.

Furthermore, at least one lower sealing element 23 is formed alongside the entire circumference of the lower mold part 6c, which is for example fastened in a respective valve seat on the mold part 6c and which is essentially situated transversally to the parting plane in case of a closed hollow mold 6 and seals against the lateral mold parts 6a, 6b.

In addition, at least one upper sealing element 24, which is for example fastened in a respective valve seat on the valve head 11 and situated essentially transversally to the parting plane in case of a closed hollow mold 6 and which seals against the lateral mold parts 6a, 6b, is formed on the front side and in full on the valve head 11. However, it would also be possible to design the upper sealing element 24 in two parts on the upper front side of the lateral mold halves 6a, 6b.

As illustrated particularly in the right half of FIG. 3 in a cross-section view, the sealing elements 22 overlap or intersect preferably with both the lower sealing element 23 as well as with the upper sealing element 24. The sealing elements can have any profiles and their sealing surfaces are made of rubber, silicone or a similar elastic material.

The hollow mold 6 and the valve head 11 could be arranged tiltably around a horizontal axis on the treatment station 5 (not shown) to enable discharge and suction of the molding fluid out of the molded container 2 when the outlet of the container 2 is facing downwards just as filling of the container 2 with product while the outlet is facing upwards. The top and the bottom side of the mold parts 6a-6c are therefore not defined with regard to their orientation on the carousel 4 but in relation to the outlet and the floor of the container 2.

After lifting of the valve head 11, the container 2 filled with product could also be closed on the carousel 4 by means of a screw cap (not shown) or a similar device. This would be particularly advantageous in case of carbonated beverages. The containers 2, however, could in principle be closed also in the area of the output star wheel 9 or in a sealing machine that is directly adjacent to it.

Suitable plastics for the hydraulic reshaping process are for example PET, PE, PP or the like.

The form-filling machine 1 can be used, for instance, as follows:

The preforms 3 are transported through the furnace 7 as a continuous product flow, heated in that furnace to a suitable temperature for the subsequent reshaping process and transferred to respectively one treatment station 5 by the input star wheel 8. A direct transfer of the preforms 3 from an injection-molding machine to the input star wheel 8 would also be possible.

Respectively one preform 3 is placed with the area to be deformed, for example the area below a support ring that might possibly be installed on the preform 3, in one of the hollow molds 6 that are continuously moving on the carousel 4 in way that is in principle known, and the pertaining valve head 11 is placed onto the hollow mold 6 and the preform 3 by lowering it in a hermetically sealing way.

The incompressible molding fluid is led with a predefined overpressure and a predefined temperature through the valve head 11 and the fluid nozzle 12 into the preform 3 and the preform 3 is thereby hydraulically pressed. This is preferably supported through mechanical stretching of the preform in its longitudinal direction.

Pressure and temperature of the molding fluid are preferably programmed with the hydraulic compressor 20 and the heating element 21 during pressing in a way as to adapt them to predefined chronological sequences for the individual reshaping process. The adaptation is done, for example, through entry and/or start of programs on the form-filling machine 1. Air that has been displaced in the hollow mold 6 by the container 2 to be shaped can escape through the venting apertures 18b and the three-way valve 18a. At the end of the reshaping process, the wall of the molded container 2 fits closely with the hollow mold 6.

If the molding fluid is not a component of the product to be bottled, the container 2 shall be emptied by means of suction through the fluid nozzle 12 and the valve head 11, for example by opening the valve 16a and/or 17a in the line 16 and/or 17. This can be supported by transporting the container 2 temporarily upside down.

An internal negative pressure created in the container 2 through suction will be maintained for the subsequent bottling process or further reduced through additional suction. In compensation, an external negative P2 is created between the external wall of the container 2 and the hollow mold 6 through suction, for example by means of opening the valve 18a towards the suction line 18 in order to prevent collapsing of the container 2 due to the internal negative pressure P1 that exists in the container 2 during filling.

In case of an internal negative pressure P1 in the container 2, the valve 15a in the feed line 15 is opened in order to direct the product into the container 2. For this purpose, the product is preferably provided with a suitable overpressure in the feed line 15. After reaching the predefined filling volume, the valve 15a is closed again, the hollow mold 6 is opened and the filled container 2 is taken out and transferred to the output star wheel 9.

The container 2 is closed, for example, in the area of the output star wheel 9 or in a sealing machine that is coupled to it. Sealing would equally be possible in the circulating treatment stations 5 where it would be particularly advantageous in case of carbonated beverages.

As an alternative to the abovementioned filling process, the molding fluid could be a component of the product and be removed only partially from the molded container 2. This would be possible both through suction of the excess molding fluid as well as through displacement of the excess molding fluid during feeding of at least one further product component. Therefore, the feed line 15 is preferably used and the valve 15a is opened. However, the feed line 14 could also be used alternatingly to add the molding fluid and at least one product component. The product to be bottled is consequently mixed in the container 2 within the hollow mold 6 in case of this bottling variant.

The form-filling machine according to the invention and the abovementioned process for molding containers and bottling a product in the hollow mold could be modified in any way that is technically useful in the context of the described design variants.

1. The process for molding and filling of containers made of plastic, in which preforms are reshaped into containers in hollow molds by at least partial introduction of an incompressible molding fluid under overpressure, and in which the containers in the hollow molds are filled with a product by replacing the molding fluid by the product or partially replacing the molding fluid by at least one component of the product.

2. The process according to claim 1 in which the preforms are mechanically stretched prior to or during introduction of the molding fluid.

3. The process according to claim 1 in which the pressure of the molding fluid is respectively changed in a controlled way during reshaping of the preforms.

4. The process according to claim 1 and the molding fluid is heated for the reshaping process, for a time section of the reshaping process, to a conditioning temperature for conditioning of the plastic, and cooled down in relation to that temperature, during the reshaping process.

5. The process according to claim 1, the molding fluid including at least one of sterile water or a sterilization agent that is rinsed out of the container with sterile water.

6. The process according to claim 1, in which an internal negative pressure (P1) is created in the container for the filling process of the product or the product component.

7. The process according to claim 6, in which the internal negative pressure (P1) is created at least partially through suction of the molding fluid out of the container.

8. The process according to claim 6, in which an external negative pressure (P2), which counter-acts the internal negative pressure (P1) on the container in a compensatory way, is created to fill in the product on the external side of the container.

9. The process according to claim 6, in which the product or the product component is put into the container, to which an internal negative pressure (P1) is applied, under overpressure conditions.

10. The process according to claim 1, and the container is turned from a position with a downward facing outlet into a position with an upward facing outlet directly prior to the filling process.

11. A form-filing machine to implement the process according to claim 1, with several treatment stations that are adapted for selective introduction of the molding fluid into the preforms and for selective introduction of the product or the component of the product into the containers.

12. The form-filing machine according to claim 11, and the treatment stations comprise valve heads with feed lines, which extend through the valve heads and/or that can be closed in a controlled way, for the molding fluid and the product or the component of the product.

13. The form-filing machine according to claim 11, further comprising suction lines, that at least one of can extend through the valve heads or can be closed in a controlled way, to suck the molding fluid out of the containers and generate an internal negative pressure (P1) within the containers.

14. The form-filing machine according to claim 12, the treatment stations further comprising sealing elements to hermetically seal mold parts, that each form one of the hollow molds, against each other and with regard to the respectively associated valve head.

15. The form-filing machine according to claim 11, further comprising venting ducts provided in the hollow molds, which can be at least one of closed or connected to suction lines in a controlled way in order to create an external negative pressure (P2) in the hollow molds outside of the containers.

16. The form-filing machine according to claim 15, the treatment stations further comprising individually controllable compressors and heating elements for the molding fluid.
